(19) United States
(12) Patent Application Publication
(10) Pub. No.: US 2013/0290239 A1
(43) Pub. Date: Oct. 31, 2013

(54) METHOD AND A SYSTEM FOR SERVICE LIFECYCLE MANAGEMENT IN NETWORKED ENVIRONMENTS

(71) Applicants: Luis M. Vaquero, Madrid (ES); David Perales, Madrid (ES); Juan Caceres, Madrid (ES)

(72) Inventors: Luis M. Vaquero, Madrid (ES); David Perales, Madrid (ES); Juan Caceres, Madrid (ES)

(73) Assignee: TELEFONICA S.A., Madrid (ES)

(21) Appl. No.: 13/884,443

(22) PCT Filed: Aug. 11, 2011
(86) PCT No.: PCT/EP2011/004038

§ 371 Date: Jul. 11, 2013

(30) Foreign Application Priority Data
Nov. 10, 2010 (ES) P 201001433

(51) Int. Cl. G06N 5/02

(52) U.S. Cl. CPC G06N 5/025
USPC 706/47

(57) ABSTRACT

The method comprises defining the workflow of a service lifecycle by means of a state diagram and following its evolution and adaptation using rule-based adaptation mechanisms enabling the transformation of services to change in response to user requirements, and delivering to said rule-based adaptation mechanism user predefined application information, which declaratively defines the architecture of an application formed by several services or said architecture plus the behaviour of the whole application under a series of variable circumstances, and using said rule-based adaptation mechanism to process and enforce at run time at least said user predefined application information. The system is arranged and intended for implementing the method, by comprising interrelated elements arranged and intended for carrying out the actions of the method.

### FIELD OF THE ART

The present invention generally relates, in a first aspect, to a method for service lifecycle management in networked environments, by defining a state diagram and following its evolution and adaptation using rule-based adaptation mechanisms, and more particularly to a method intended for managing dynamic workflows in a holistic manner, processing user predefined application information stated by a user at design time.

A second aspect of the invention relates to a system adapted for implementing the method of the first aspect.

### PRIOR STATE OF THE ART

Despite the recent Networked-based solutions that have appeared on the ICT market (specially in the area of Cloud computing), there are still important gaps to be filled that are not solved by any of those commercial offers, neither by academic activities to the best of the knowledge of the present inventors. One of the main gaps detected is the lack of service-level management capabilities of present solutions.

Present commercial networked service providers (also dubbed as Clouds) such as Amazon EC2 [1], GoGrid [4] and FlexiScale [3], or solutions as Eucalyptus [2] all focus on the management of virtual machines (VMs) and their connections. However, they do not consider the management of services as a whole, so Cloud customers (Service Providers, SP) lack tools to handle their services as a single unit. Thus, for example, when deploying a new service the SP has to install the VMs that form the service as individual units, while it would be more convenient (and closer to the SP experience) to deploy the service as a single entity.

Service lifecycle is typically expressed in the form of state transition diagrams. The diagrams in FIG. 1 express a set of states in which the service is up or down and respective substates within these previous two.

This rigid schema may work well for static environments in which either the state diagrams or the processing one does not change on a frequent basis, much less so suffer on-the-fly changes. The control of a service lifecycle concerns the development, delivery and evolution of individual services. This relates to principles used during the design, development, delivery and maintenance of these services. Service lifecycle management is, thus, a key topic present in many ICT systems (more so in dynamic systems such as the Cloud and other networked systems), the problem is dealt with by different technologies and at very different abstraction levels:
Virtualization and Cloud technologies are not immune to the need of managing the services they help to deliver. Thus, offer cost-effective and rapid resource scalability as well as greater flexibility in providing hardware resources to service demands. For instance, the DTMF (Distributed Management Task Force) proposes a static lifecycle for all the machines deployed on a given hypervisors. This approach is very limited and it will be shown here how it cannot be accommodated to manage the expressive richness required for service management.
In CORBA environments, the Object Life Cycle Service [5] defines conventions that allow clients to perform lifecycle operations on objects in different locations by using IDL (Interface Definition Language) interfaces without knowing about their types or semantics. An example is the LocALE (Location-Aware Lifecycle Environment) framework, which provides a simple management interface for controlling the lifecycle of CORBA distributed objects [6].
Component-based Software Engineering (CBSE) deals with the entire lifecycle of component-based products, and has been focused on technologies related to the design and implementation of software components and systems built from software components [7]. For example container components in application servers (such as EJBs containers in J2EE compliant servers) [8] and Midlets [9], etc.
Regarding service lifecycle management, interest has been raised by Service Oriented Architectures (SOA) systems, which handle services as a deployable unit. Also, some expertise is available in building intelligent software agents that, at the end of the day, work as a service themselves in the system they belong to [10]. Agent technology has been used to address some of the key problems of Service-oriented Computing contributing to the wide adoption of the Service-oriented Computing paradigm [11]. The work by Mobach et al. divides the service-agent states in an activated state where the service is running and pursuing its goal; a suspended state where the service can be reconfigured, a migrating state, and a storage state where the service is being removed and stored for future usage [10]. However, the management aspect of Service-oriented infrastructures, which also need to be tested, monitored and maintained, is often neglected in these technologies [12]. SOA lifecycle management includes deciding on service granularity, change management procedures for services and on registration of available services in the SOA. Service lifecycle control aims at consistency between services, which is expected to improve their manageability [13]. In dynamic Web service environments, policies often need to be modified to accommodate changing business strategies. Changes to laws and regulations also force enterprises to update their policies. Security holes may be discovered, which need to be rectified. In general, lifecycle management has been recognized as an important problem and has been studied in several different domains (see e.g. [14, 15]). Service lifecycle control raises some new specific issues that are less of a problem in traditional application lifecycles. The distributed nature of the service development process may lead to unregistered services that cannot be governed entering the SOA. This may result in the development of similar services because of insufficient knowledge of the functions provided by existing services or services built by other developers. Changes in the responses of a service may require changes in other services that invoke the changed service [13]. In, these SOA architectures, the service itself and its code is usually located on some application server, but documentation, policies and metadata about versioning of the service is contained in the repository. Service registries can be used by governance bodies to impose validations or other checks to be performed before a service is published. Registries can also support the rights management of users by checking if they are authorized to use a certain service. However, neither of these problems is present in a Cloud environment. Ad hoc deployments in Cloud environments and the isolation provided by virtualization technologies confer a relative advantage to Clouds over traditional SOA architectures. Some approaches help simplify integration at higher abstraction levels such as business-level interaction protocols [16]. IBM's Service Information Hub provides information management capabilities for Recycle management [17]. The Service Information Hub is aimed at supporting end-to-end service lifecycle management via integrated information framework with value-add information and analytics services. This work suggests the usage of additional services for processing the incoming data and react, changing the lifecycle state not only according to raw data, but also to processed data (e.g. statistics).

FIG. 2 further illustrates the list above. It can be observed how the available state of the art offers lifecycle management solutions for “low-level” elements offered as a service (e.g. Amazon EC2 exposing services to create virtual machines on physical nodes) and other traditional elements used in software engineering (such as solutions for controlling the lifecycle of different software abstractions).

Unlike other solutions above, SOA-based workflow systems provide the needed abstraction level for taking applications to the Cloud, letting users focus on their core business and specifying application lifecycle in abstract terms closer to their daily language. Thus, it is worth exploring them with more detail to broaden the provided background and help the understanding of the proposed challenges and contributions of the present invention.

Workflow technology has been the subject of extensive standardization and is broadly accepted. The most prominent workflow standardization community is the Workflow Management Coalition (WfMC). This organization provided a reference model for Workflow Management Systems (WfMS) that allows for the interoperability between WfMSs developed by different vendors. Interoperability is enforced by implementing standardized APIs. However, there is no standardized model for the process definition itself, and therefore all vendors are free to develop their own workflow models. The WfMC specifies the XML Process Definition Language (XPDL) that is used for exchanging process definitions across different workflow engine implementations. Workflow engines are the core technology concept; they are in charge of executing the process models created by users employing a model description language.

There are a lot of workflow definition languages, such as Web Services Business Process Execution Language (WSBPEL) [18], BPEL4WS or the Grid Workflow Execution Language (GWEL) [19], jBPM Process Definition Language [20], which have been criticized elsewhere [21]. Also, there are available many solutions for process execution such as Apache ODE, JBoss jBPM, etc. The fact that there is not a lack of tools should encourage the adoption of workflow-based solutions for service management. There are two groups of languages, based on different process calculi (formal models for concurrent systems definition) and, therefore, they have distinct operational semantics. Existing Web Service-flow languages are block-structured whereas the traditional workflow languages (XPDL, MOBILE) are based on a directed-graph. Block-structured languages are more appropriate for expressing much more complex control flows and they are able to provide support for distributed business processes in which exception handling can be interleaved with the business logic. It is very important to realize that block-structured process definition languages are more suitable for enabling transactional support for long-running business interactions. In the case of long-running transactions compensating activities have to take a meaningful corrective action that allows the process execution to continue, rather than simply reversing the effect of completed activities and terminating the whole process. BPEL4WS provides a hybrid solution combining language elements corresponding to both block-structured and graph-based models.

FIG. 3 shows how a workflow is initially edited using one of the wealth of workflow edition tools for different workflow languages. This graphic edition is traditionally mapped to a given workflow language (such as those presented above). Then, a workflow planner decides where the different workflow activities can be allocated and starts the workflow execution (see [22]). Finally, an observer (typically embodied in the form of a language-dependent rule engine) is in charge of receiving events and “move” along the workflow stage according with the systems' status.

This “traditional” model implies several limitations that will be described here. The definition of a static hardcoded lifecycle is a common approach employed by many systems [23]. For instance, Chaves et al. proposed a Java-based Service Lifecycle Manager. Change occurs frequently in business processes due to several primary reasons [24]: 1) at design time the workflow specification is incomplete due to lack of knowledge, 2) errors or exceptional situations can occur during the workflow execution, 3) normal changes in the service notion of quality of service (new metrics are received that trigger service reconfigurations or working modes and cause the service priorities to change altering the service workflow). Most of the existing commercial Workflow Management Systems are designed to handle static business processes. The common approach is to use new workflow templates when changes occur; these new instances are then initiated accordingly from scratch. This is a way too simple and inefficient approach that forces already done tasks to be executed again on the new-template instance [25]. In other words, this “move” mechanism from a deprecated running workflow instance to a newly generated no-yet-running instance of a different and more appropriate workflow is a very costly procedure when it comes to complex workflows in highly dynamic environments.

Luckily, service dynamism can be faced at very different levels. For instance, recent inventions try to make systems recover from unexpected failures by including error states and by migrating the same workflow to another available device [42] or distributed data collection mechanisms [43]. These represent primitive efforts towards fault tolerance, but they remain too specific. Some other authors proposed a service composition platform that supports the lifecycle of dynamic compositions both at design-time and at runtime, Bastida el at. [39] posed the question on how to support the dynamism of the composition defined at design time during execution. There are different solutions to deal with runtime binding. Some of these solutions suggest rule engines or configuration files to collect the needed information and using redirector of the service invocation. Addition of extra runtime sub-phases to more conventional state diagrams have also been proposed [39]. Also dynamic workflow systems, like ADEPTflex [31] have been designed to support dynamic changes at runtime. Other previous attempts failed to map their flexible workflow specification by means of preloaded scripts to a human readable state machine and focused on the service (rather than on the whole application) [32]. Yet other solutions rely on a mapping mechanism from workflow specification to hardcoded rules [33]. This does not deal with the intended dynamism inherent to current networked systems. Also, this latter solution stored incoming events prior to checking the hardcoded rules. This step is not usable for real time systems.

Dynamic changes at runtime may be constrained by the existence of dependencies among different service components that may need to be preserved at runtime, or rather, may evolve together with the lifecycle stage the service is dwelling into. The Cloud and modern networked systems is an especially sensitive environment to such dependencies, since the available components are not there and a workflow planner is in charge of allocating requests to existent predefined resources, but the “resources” are created on demand (see FIG. 4), unlike previous approaches in which the workflow planner had to look for the available resources [34]. In this new scenario it becomes increasingly important to manage application component (service) dependencies appropriately.

Keller and Kar introduced the concept of lifetime dependency, which relates the flow of dependency information throughout the whole service lifecycle (from the design to installation to runtime stages) [35]. This topic is not, however, new and some authors dealt with it before [36], introducing the idea of cooperation relationships to those of aggregation and association. The identification of dependencies is more and more important since applications rely on a variety of supporting services that might be outsourced to a service provider. Failures occurring in lower service layers affect the QoS of the services that are offered to customers. Most of the approaches to lifecycle control mentioned in the state of the art rely on sticking different service components together, disregarding the relationships that actually glue them together. The dependences among service components are only typically observed at deployment time. This is mainly due because only component relationships are considered, although Keller and Kar [35] proposed many more dependencies (space, domain, activity, strength, temporality, etc.) that need to be studied to enrich the service component interrelations, but preserving the high flexibility of the service lifecycle. The complex interdependencies between their distributed system parts, assuring that services are delivered at a high level of quality is challenging. These interdependencies should be considered as first-class citizens in order to provide sophisticated services lifecycle [37].

Service dependencies are not made explicit in today's systems, thus making the task of problem determination particularly difficult. Solving this problem requires the assessment and resolution of dependencies between services and applications [35].

Petri Nets are a likely approach for implementing these relationships. They can be used to model sequentially, mutual exclusion, and concurrency of system activities, and they support concepts for a stepwise formalization, as well as methods for the stepwise refinement of system descriptions. There exist different types of nets. Low-level nets (e.g., condition/event nets, place/transition nets [38]) allow an easy interpretation of net components, and they are easy to understand, but rather hard to handle in case of large systems with complex behaviour. In high-level nets (e.g., predicate/transition nets, coloured Petri nets), the basic components are more expressive and allow a more compact description than in low-level nets. It is generally agreed that, for practical purposes, high-level nets are more desirable than low-level nets. Aspect oriented programming can also be seen as a mechanism to introduce certain degree of flexibility to current workflow engines.

The design of dynamic workflows needs appropriate modelling formalisms to handle changes during normal and exceptional workflow operation. Classical Petri nets, however, have a fixed topology, so they are well suited to model workflow matching a static paradigm. Conversely, supporting dynamic workflows is a limitation of classical Petri nets, dynamism/evolution must be hardcoded in the net model and bypassed when not in use [25]. This requires practical experience in modelling, imposing a relevant technification problem that often results in incorrect or partial description of workflow behaviour. Also, the analysis of the appropriate net could be polluted by evolutionary details. Separating evolution from the (current) system behaviour is worthwhile. This concept has been recently applied to a Petri net-based context [26], using reflection as a mechanism that easily permits the separation of concerns. Further dynamic Petri-nets extensions have appeared [27, 28, 29, 30, 31].

Current services lifecycle management is far from being autonomous; indeed, service autonomy is commonly achieved through rule-based adaptation mechanisms [40, 41]. Pfeffer et al. proposed a biologically inspired lifecycle, enabling service evolution and adaptation of the state diagram defining the service lifecycle. This concept enables the transformation of services to change in response to the user requirements [41]. Further extensions are still needed to deal with service adaptation not only in response to user demands, but also to some predefined behaviour stated by the user at design time which must be enforced at run time. This evolution should not only change the diagram of states defining the overall service lifecycle, but also means are needed to dynamically change the events triggering the transitions between states. For instance, users may want their service running but not scaling for a given time frame in order to perform some maintenance tasks. In a static lifecycle, incoming events will change the status of the application. Having a dynamic lifecycle control for all the services composing the application, allows for a further control of the actual behaviour of the application.

A final potential pitfall for dynamic service lifecycle management systems is the broad SOA installed base in current systems. Workflows are usually specified in some of the aforementioned languages (in a static manner). A flexible service lifecycle management system must also be capable of providing “backwards compatibility” to support the wide base of already installed and running services.

Most commercial framework automation solutions (from companies such as HP, BMC, CA, IBM and EMC) cannot scale to the demands of highly dynamic automated operations simply because these are built on architectures driven by inflexible and manually constructed scripts and templates (akin of the traditional command-line interfaces). In addition, they do not support the specification and enforcement of user-defined metrics, behavioural rules (e.g. those controlling how services scale as a whole entity, rather than on a per VM basis).

Problems with Existing Solutions:

As anticipated, several problems arise when analyzing the existent solutions. These can be short-listed as follows (and illustrated in a more operational manner in FIG. 5):

1. Existent technologies for service lifecycle management run short when it comes to provide the abstraction level required by users (application level). Users often want to focus on their business case, forgetting about tower level details. In other words, users want to control the lifecycle of applications in a holistic manner (as a set of interrelated services).

2. Workflows in SOA architectures follow immutable static paths in which neither the basic state diagram nor the triggering transitions or their related events can be altered once the application has been deployed. New solutions enabling dynamic workflows able to change “as it goes” are required to deal with services' inherent volatility and changing needs. Service lifecycles are often standardized, but the rigid standard state diagrams are not a one fits all solution. Indeed, custom lifecycles may prove useful to gain competitive advantage over rival products, since they may result in more appropriate management of the service and reduced number of service outages.

3. Dynamically managing complex dependencies among application components is more complicated in adaptive systems. Automated mechanisms are needed to preserve the proper deployment, runtime and undeployment constraints of a SOA-based application. In other words, controlling the behaviour (dependencies, scalability, etc.) of the application in a holistic manner by allowing for using custom metrics is a gap in current state-of-the-art technologies. None of the available systems currently supports this, as shown in FIG. 5.

4. The relatively high technical profile required to create a working workflow is also a very relevant problem. This problem has been widely dealt with in the literature, but it also points to a very likely language lock-in. Once a service's workflow has been defined in a given language, it takes time and effort to migrate this specification to another language. The analysis of the state of the art reveals the lack of a general enough system to allow for the usage of whatever needed workflow system. This feature will also help to mitigate the problem of backwards compatibility that applications in the Cloud suffer when they are being migrated to this new ecosystem.

### Description of the Invention

It is necessary to offer an alternative to the state of the art which covers the gaps found therein regarding service lifecycle management.

To that end, the present invention provides a method for service lifecycle management in networked environments, comprising defining the workflow of a service lifecycle by means of a state diagram and following its evolution and adaptation using rule-based adaptation mechanisms enabling the transformation of services to change in response to user requirements.

The method comprises, in a characteristic manner, delivering to said rule-based adaptation mechanism user predefined application information, which declaratively defines the architecture of an application formed by several services or said architecture plus the behaviour of the whole application under a series of variable circumstances, and using said rule-based adaptation mechanism to process and enforce at run time at least said user predefined application information.

According to an embodiment, the method comprises using a machine interface to directly create and modify an input file including said user predefined application information.

For an embodiment, the method comprises mapping said user predefined application information to a data model consisting of states, transitions and generic events, to obtain a set of rules representing the incarnation of said application, including the workflow tasks and/or new states and/or transitions of said workflow, and loading said set of rules into a rule controller, said data model and said rule controller forming part of said rule-based adaptation mechanism.

Before loading said set of rules into said rule controller, the method comprises, for an embodiment, checking them against a set of predefined adaptation policies that check business and performance criteria, said predefined adaptation policies being implemented into said rule-based adaptation mechanism.

In order to generate said set of rules, the method comprises, according to an embodiment, analysing dependencies between services forming said application.

For an embodiment, the method comprises the direct usage of a provided interface to create and load said user predefined application information, in the form, for example, of a declarative or instructional input file from a graphic editing tool, while for an alternative embodiment the method comprises using some intermediate phases including a language determination and a translator for translating the user predefined application information before checking it against said set of predefined adaptation policies.

At least part of said enforcing at run time of at least said application information is carried out, for an embodiment, by monitoring incoming events and triggering state changes by enforcing the set of rules loaded in the rule controller.

According to another embodiment, the method comprises deploying and/or modifying the services forming the application before a stage of said monitoring incoming events is carried out.

Moreover, the method of the first aspect of the invention comprises, for an embodiment, storing said monitored incoming events in a database, analysing the stored events (such as by means of advanced data mining techniques or any pruning technique) in order to find hidden information patterns and new usable rules to optimize the application lifecycle and loading said new usable rules into said rule controller, preferably after checking them against said set or another set of predefined adaptation policies that check business and performance criteria.

The method comprises, for an embodiment, conditioning at least the loading of said new usable rules into said rule controller to the decision of an operator, although for another embodiment said loading is automatic.

For a case for which the user predefined application information does not include behavioural policies, the method comprises comparing said user predefined information with older information, analysing the differences found and enforcing required actions depending on the results of said differences analysis.

Said comparison of predefined and older information is carried out, for an embodiment, to check which components have been added, how the dependencies have changed and what is needed to reach the new run time state from the previously deployed architecture.

Said enforcing of required actions comprise, for some embodiments, deploying new software elements (such as a .war file deployed on top of an application container) or virtual machines, and configuring them to interoperate with the rest of previously deployed elements comprising the whole application.

The method also comprises, for an embodiment, dynamically changing or putting on a hold state (such as an unobserved state) said rules loaded into said rule controller and said incoming events.

The method comprises observing said rules loaded into said rule controller, preferably, as soon as they are loaded.

A second aspect of the invention relates to a system for service lifecycle management in networked environments, of the type comprising computing means implementing, by software and/or hardware elements, a method for service lifecycle management in networked environments comprising defining the workflow of a service lifecycle by means of a state diagram and following its evolution and adaptation using rule-based adaptation mechanisms enabling the transformation of services to change in response to user requirements.

In a characteristic manner, in the system of the second aspect of the invention said computing means comprise at least one input for receiving user predefined application information, which declaratively defines the architecture of an application formed by several services or said architecture plus the behaviour of the whole application under a series of variable circumstances, and the computing means are arranged and intended for processing and enforcing at run time, using said rule-based adaptation mechanism, at least said user predefined application information.

The system of the second aspect of the invention comprises interrelated elements arranged and intended for carrying out the actions of the method of the first aspect of the invention, for different embodiments.

### BRIEF DESCRIPTION OF THE DRAWINGS

The previous and other advantages and features will be more fully understood from the following detailed description of embodiments, some of which with reference to the attached drawings (some of which have already been described in the Prior State of the Art section), which must be considered in an illustrative and non-limiting manner, in which:

FIG. 1 is a typical state diagram for web services (from http://www.w3.org/TR/wslc/);

FIG. 2 shows schematically an overview of the lifecycle management capabilities available in the market;

FIG. 3 show a diagram with the traditional modules included in the definition and execution of a given workflow;

FIG. 4 shows an on demand provisioning model (left view) vs. traditional brokering schemes (right view);

FIG. 5 shows an overview of current state of the art procedures;

FIG. 6 shows the adaptive behaviour provided by the method of the first aspect of the present invention;

FIG. 7 shows a diagram representing a simplified application lifecycle management, more abstract than that of FIG. 3;

FIG. 8 shows the procedures of the art of FIG. 2 plus the one providing a higher abstraction level offered by the method of the first aspect of the present invention;

FIG. 9 depicts a mapping mechanism procedure implemented by the method of the first aspect of the invention, for an embodiment;

FIG. 10 is a diagram illustrating the different elements of the system of the second aspect of the invention used for carrying out the different actions of the method of the first aspect of the invention, for an embodiment, where the arrow lines indicate the flux of data between the different elements or modules;

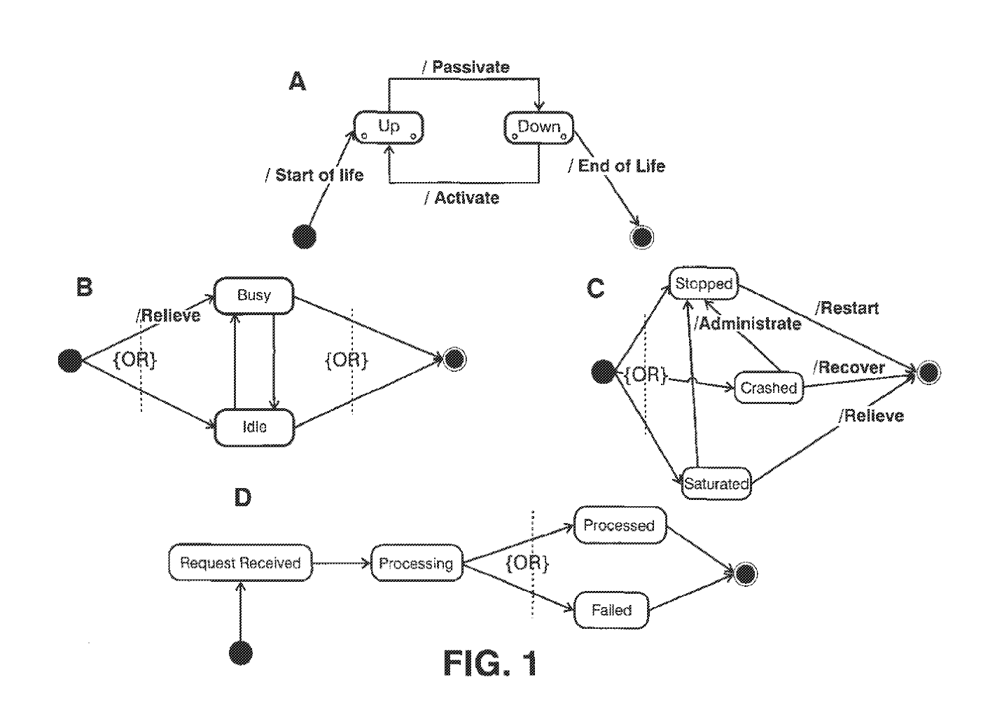

FIG. 1 is a sequence diagram of the logical operations followed in the method of the first aspect of the invention, for an embodiment; and

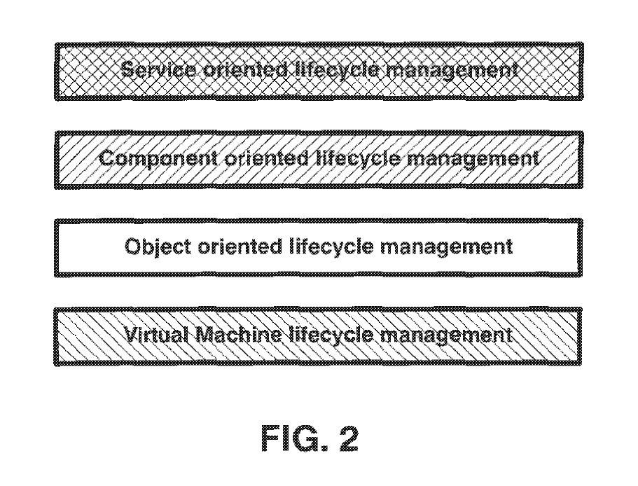

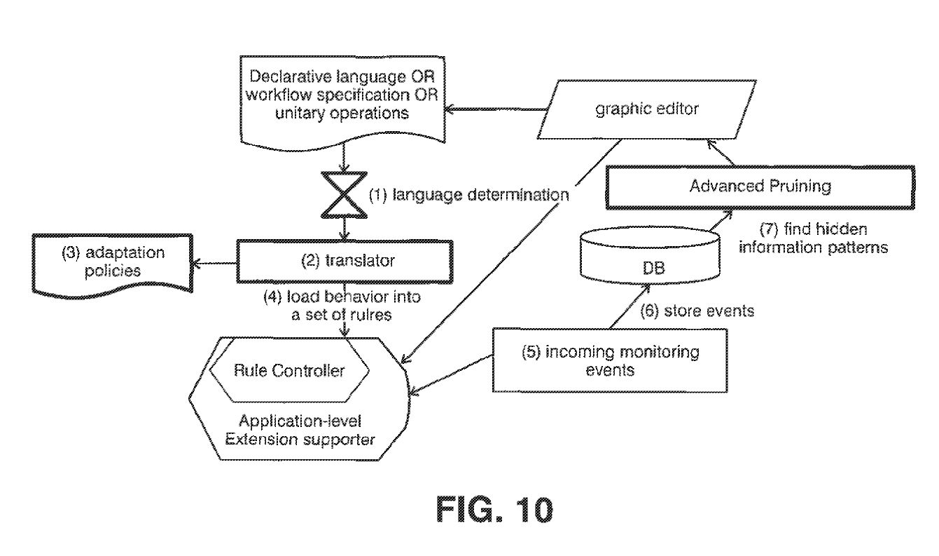

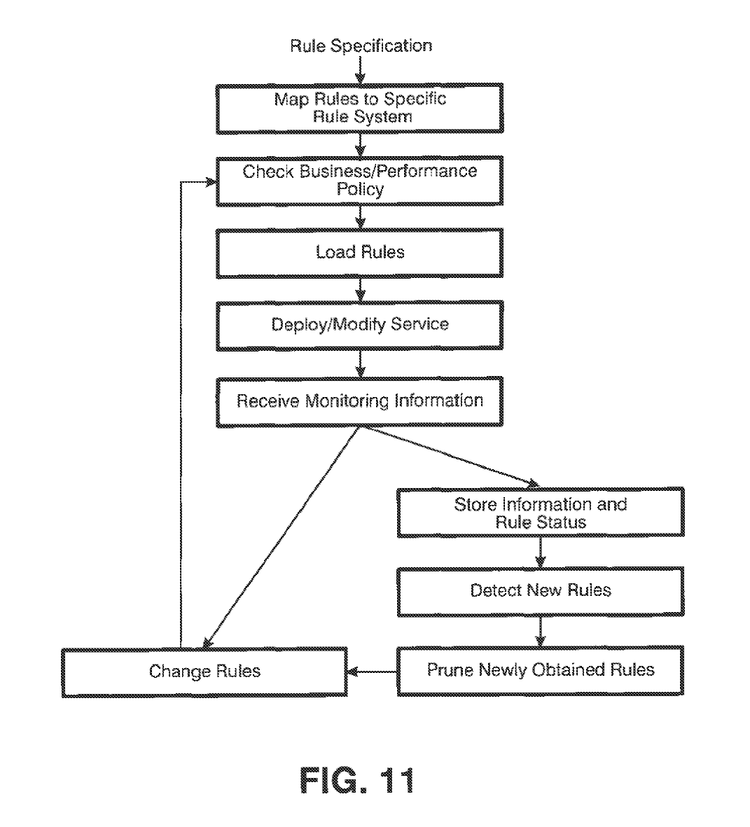

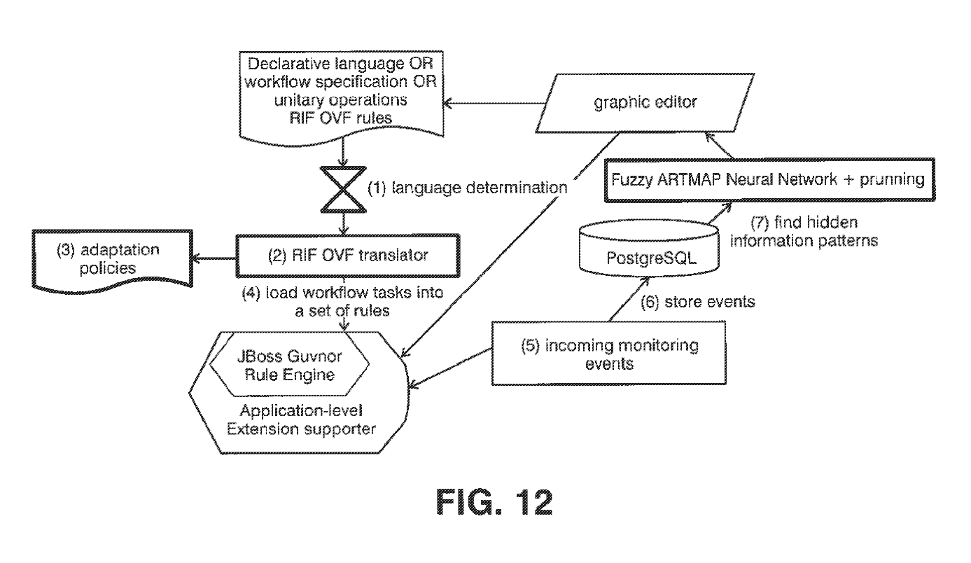

FIG. 2 is a diagram analogous to that of FIG. 10, but indicating some software tools implemented by some of the illustrated elements, for a specific embodiment of the invention.

### DETAILED DESCRIPTION OF SEVERAL EMBODIMENTS

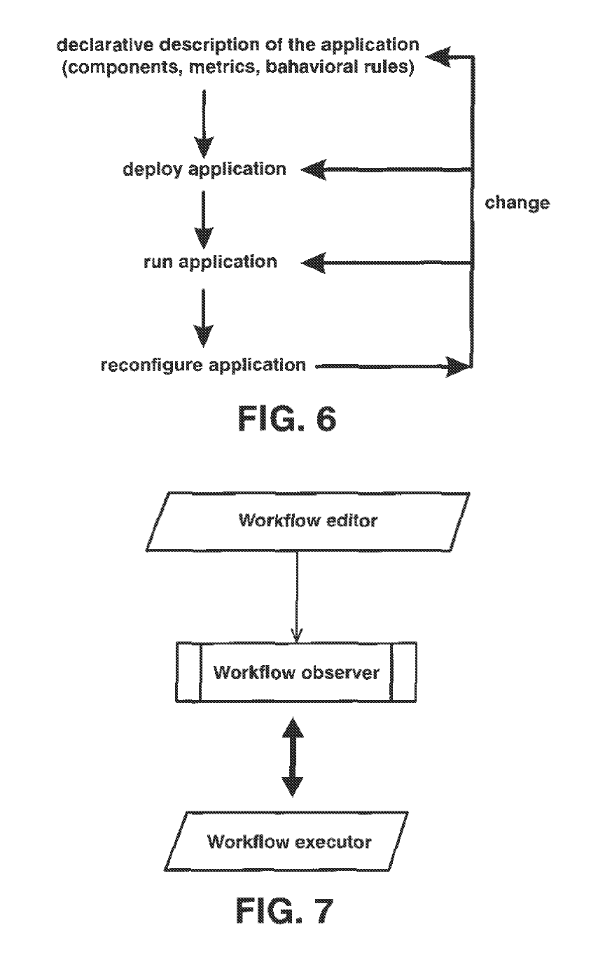

Referring to FIG. 6, it schematically shows the adaptive behaviour provided by the method of the first aspect of the present invention, for an embodiment, where the reconfiguration of the application carried out by any of the means previously explained (by adding new usable rules form incoming events, by creating/modifying the user predefined application information, etc.) affects, i.e. changes, the declarative description of the application and the application deployment and running.

By the method of the first aspect of the invention:
the required abstraction level is provided by letting users focus on their core business, trusting the control of the services that compose the application to the lifecycle controller implementing the method of the first aspect of the invention.
states, transitions and events in a service workflow can be altered as needed without the need to shutting the application down. A formal process for dynamically specifying state machines and allowing changes on the fly is herein proposed. The inherent Cloud dynamism in which services proliferate and need to be rapidly modified to keep up with demand and new requirements calls for dynamic lifecycle management mechanisms.
the proposed invention dynamically analyzes and solves application component (services) interdependencies and restriction on the holistic behaviour of the application and takes these into account when it comes to allow for new states, transitions and events (user defined metrics, as shown in FIG. 6). Current scheduling strategies do not fit with the dynamic nature of on demand provisioning enforced by the Cloud.
the inclusion of translating modules in the process provides the needed independence from the employed workflow language.

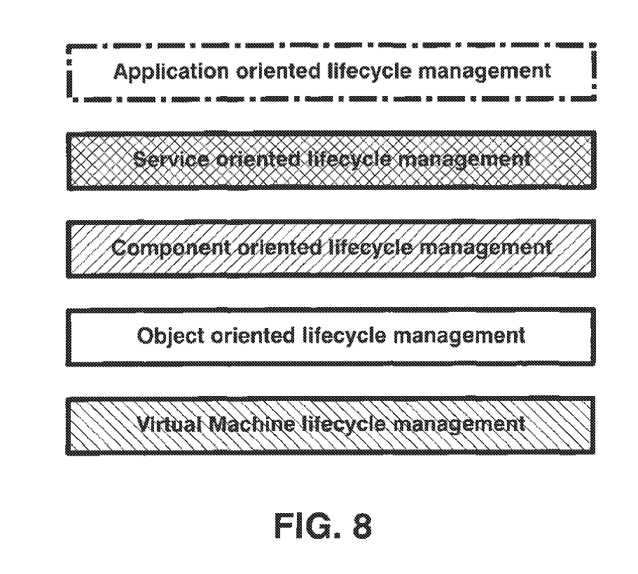

FIG. 7 presents a more simplified view of the problem of lifecycle control in SOA-application management. The solution provided by the method of the first aspect of the invention offers higher abstraction than current state of the art elements, allowing users to manage applications in a holistic manner (see FIG. 8).

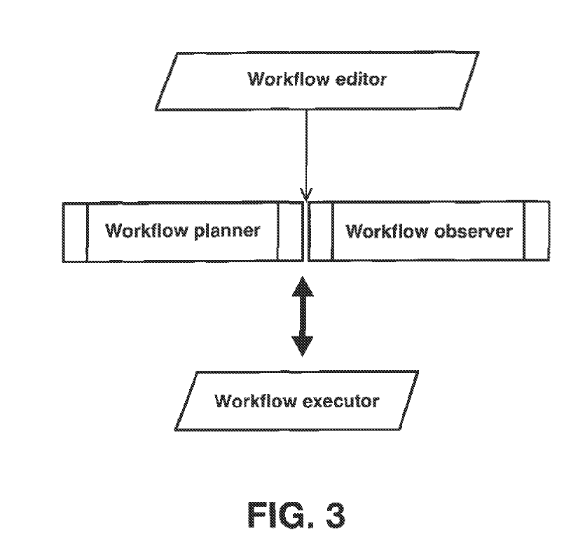

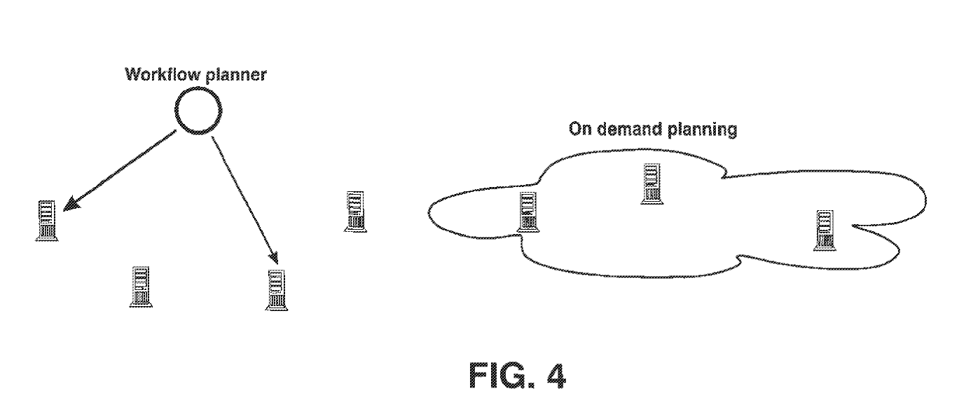

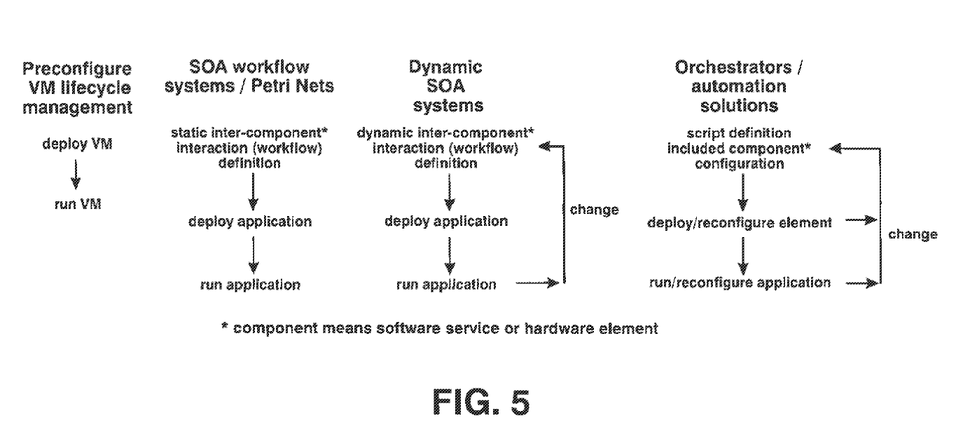

The simplified overall view of the proposed method, as compared to the diagram shown in FIG. 3, i.e. the dispensing with the workflow planner, does not come for free. This simplification towards higher abstraction level implies adding additional stages to the process of workflow definition and enforcement. In other words additional interactions need to be performed.

The method and system of the invention present several innovation points embodied in additional processes within the workflow observation stage described above (see light grey elements in FIG. 10). The method and system have several input points:

1. A behaviour-specifying file as created manually, by means of graphic tools or any other available mechanism that declaratively defines either the architecture of the application OR the architecture plus the behaviour of the whole application under a series of variable circumstances.

2. A machine interface to create and modify an input file directly.

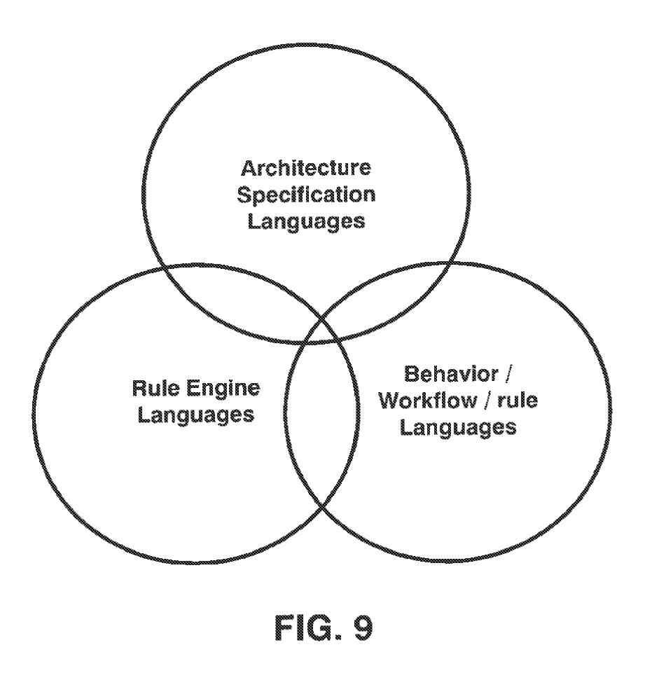

In the first case, as shown in FIG. 10, a language determination module (1) is included that identifies the language used in the provided file. Changes in the file are mapped to a data model consisting of states, transitions and generic events that can be impersonated to suit specific monitoring needs and data formats (2). Also, the invention envisions the direct usage of a provided interface to create and load the declarative or instructional input file from the graphic tool (avoiding intermediate phases, such as (1) and (2)). The mapping procedure involves using only the shared structures at the intersection among different architectural specification languages (e.g. OVF, libvirt, CDDLM, etc.), generic rule/workflow/behaviour specification languages (such as BPEL, RIF, BPDL, RuleML, OWL, SWRL, Lisp, etc.) and the most widely employed specific rule languages (like Drools' DRL and Jess), as shown in FIG. 9. These functions are performed in steps (1) and (2). More specifically, the language determinator identifies the language used for expressing the behavioral rules and the translator converts it to the appropriate representation for being processed. The architecture and/or behavioral specification mapped as a set of rules is checked against a set of predefined adaptation policies (3) that check business and performance criteria (e.g. avoid going beyond a pre-defined budget, maximize the cost to benefit ratio, etc.) before loading (4) the set of rules representing the current application incarnation. In step (4), it is critical to analyze dependencies among application components (services) so as to define the appropriate set of rules describing the intended system. For instance, a database should be deployed before its web server so that the underlying infrastructure assigns an IP address to the database and the web servers automatically gets this information without any manual intervention. Such contextualization features are essential in dynamic environments such as those herein presented where many components can be deployed or undeployed during the application lifetime. Also, rules for configuring and controlling how and when applications are scaled with regards to these identified dependencies are inferred at this point. Language-specific elements are included that allow to specify and dealt with these dependencies. If an architectural file is provided with no behavioral policies, the application-level extension supporter is also in charge of detecting changes in the configuration (by analyzing differences between the old and the new file) and enforcing the required actions (e.g. deploying new VMs or software components and configuring them to interoperate with the rest of previously deployed elements comprising the whole application). These actions are carried out by the Application-level Extension supporter in FIG. 10.

This exposed interface for loading rules (and of course the mapper between the architecture/behavioural input file and the rules), together with the usage of a rule based data model to describe the application and its behaviour, are the core elements to provide users with the required level of flexibility and on-the-fly adaptation: rule controllers check incoming events against the loaded rules. Both, rules and facts can be dynamically changed (added/removed/modified) or put “on hold” (i.e. not observed) thanks to the “application level extension supporter” module (FIG. 10). New states and transitions are easily added by the inclusion of new rules and these rules are observed as soon as they are loaded in the system.

The incoming monitoring events (5) do not only trigger state changes by enforcing the rules representing the state diagram and transitions in the rule engine, but also these events get stored in a database (6) for performing advanced datamining (pruning) techniques (7) revealing hidden information patterns and new usable rules to optimize the application lifecycle against a series of given policies (as set in (3)). These newly detected human-comprehensible rules are suggested to the operator working on the editing tool for her to analyze them and decided whether actually loading them or not. A more detailed flux diagram indicates the logical operations taking place in the design above according to the method of the first aspect of the invention is shown in FIG. 11, in a sequence indicated by the arrow lines connecting the different illustrated boxes.

All the modules shown in FIG. 10 are comprised by the system of the second aspect of the invention, for an embodiment, said modules being interrelated as indicated by the illustrated arrow lines.

Several architecture/behaviour languages are available in the market, some of them with a widespread adoption. Also, several rule engines can be included in the diagram above that fit the specific needs. Less variety is given when it comes to obtain a workable set of human-comprehensible rules, though. A specific architecture/specification language is shown in FIG. 12 (including specific elements, such as OVF, extended by using the Rule Interchange Format, RIF, for expressing behavioural rules). Then, a concrete rule translator in charge of mapping behavioural rules (RIF-based and OVF-embedded) to Rule Controller-specific rules representing states and transitions is implemented. The chosen Rule Controller was JBoss Guvnor, which already exposes a web interface that can be exploited so as to manage rules on the fly, as needed. Worth mentioning is also the inclusion of Fuzzy ARTMAP neural networks, which generate a reasonable number of rules from the stored data (runtime metrics and historic information) that can be employed to obtain hidden patterns. The neural network is confronted against the available policies (embodied in the form of a database) and the stored incoming events. To further reduce the number of rules produces (and increase comprehensibility) pruning techniques can also be applied and fed back to the graphical editor as suggestions for users to optimize their workflows.

In this specific embodiment of the invention a mandatory initial state is implemented in the application lifecycle that is aimed at waiting for business notifications to become ready prior to performing an actual deployment/reconfiguration of the service.

### Advantages of the Invention:

The method and system of the present invention expand currently existing rule systems with a series of modules to enhance their performance and provide appropriate abstraction level and flexibility in rule modification at runtime. This invention proposes mappings between high level user-specified rules and modules dealing with the application-level part of the rules. The mapping is performed via a module to enforce adaptation policies. Having a set of pruning mechanisms extracting relevant and usable rules to feed back to the system from the stored rules is also an important advantage.

Next the main advantages of the method and system of the invention are indicated:

### Highly Abstract, Flexible Lifecycle Definition and Solving Application Component Dependencies

The definition of an appropriate service lifecycle is a very tricky question, highly dependent on the application domain and even on the application itself that may provide the enterprises with competitive advantages. Plainly said, the same set of service components with the same connections among them may behave very differently depending on the way these components are woven together. The lifecycle of a service defines these relationships and the overall behaviour of the service. Thus, the state diagram that is implemented is strategically concealed by every organization and it is difficult to find academic or industrial reports on the low level details. Flexibility is a key advantage enabling enterprises to offer a differentiated service to their customers.

The way the service components are integrated is only a part of the picture; the way these components are allowed to interact is also determinant to determine the overall service behaviour. Some deployment dependencies have already been considered (see above), such as the deployment order of the different service components, but many more dependencies (space, domain, activity, strength, temporality, etc.) are included for some embodiments of the method and system of the present invention.

### Facing the Lock-in Problem:

Rather than specifying complex workflows dependent on highly regulated languages (e.g. BPEL), the method and system of the invention delivers a fully customizable framework for service providers to build their state diagrams easily with a graphical interface. The construction of the diagrams can be started from scratch or adapting predefined state diagrams (set of states, transitions and actions) offered as templates.

A remarkably novel element is the possibility to integrate new states on-the-fly and to include actions to add/delete/update lifecycle states or transitions in the elasticity rules. In other words, the rules not only trigger transitions, but they may also modify the whole state diagram. The lifecycle manager will rely on composed metrics based either on processed or raw data to determine if a rule condition is met.

### Flexible Service-Level User-defined Metrics:

The method and system of the invention provide a bigger expressive richness than conventional proposals, allowing for service-level user-defined metrics employed to determine the way services are scaled in and out. User defined metrics require the system to provide some flexibility, so that transitions between states are defined on the basis of these newly defined metrics. These metrics are inherently different to each service and may render the actual advantage over competitors with very similar individual components, but more poorly interwoven relationships among components. The proposed system allows for the inclusion of new relevant metrics at runtime and performs an analysis to take into account the dependencies among application components (services) at deployment and runtime.

### Backwards Compatibility:

The proposed invention contains modules to adapt different traditional workflow languages to the underlying dynamic system. Thus, users may still use static workflows in any language that best suits their particular needs.

A person skilled in the art could introduce changes and modifications in the embodiments described without departing from the scope of the invention as it is defined in the attached claims.

### ACRONYMS AND ABBREVIATIONS

ART Adaptive Resonance Theory
CBSE Component-based Software Engineering
DMTF Distributed Management Task Force
EJB Enterprise Java Beans
GWEL Grid Workflow Execution Language
ICT Information and Communication Technologies
IDL Interface Definition Language
LocALE Location-Aware Lifecycle Environment
SOA Service Oriented Architectures
SP Service Provider
VM Virtual Machines
XPDL Process Definition Language
WfMC Workflow Management Coalition
WfMS Workflow Management Systems
WSBPEL Web Services Business Process Execution Language

### REFERENCES

[1] Amazon Elastic Computing Cloud. [Online] http://aws.amazon.com/ec2/
[2] Eucalyptus. [Online] http://eucalyptus.cs.ucsb.edu/
[3] FlexiScale. [Online] http://flexiscale.com/
[4] GoGrid. [Online] http://www.gogrid.com.
[5] OMG. Life Cycle Service version 1.2. Specification formal/2002-09-01, September 2002. [Online] http://www.omg.org/cgi-bin/apps/doc?formal/02-09-01.pdf.
[6] D. L. D. Ipia. LocALE: a Location-Aware Lifecycle Environment for Ubiquitous Computing. In Proceedings of the 15th International Conference on Information Networking (ICOIN-15, 2001).
[7] I. Crnkovic, S. Larsson, and M. Chaudron. Component-based development process and component lifecycle. In ICSEA06, Tahiti, French Polynesia. IEEE, 2006.
[8] M. Trofin and J. Murphy. A Self-Optimizing Container Design for Enterprise Java Beans Applications. In Proceedings of the Second International Workshop on Dynamic Analysis (WODA 2004), May 2004.
[9] E. Ortiz. Managing the MIDIet Life-Cycle with a Finite State Machine, August 2004. [Online] http://developers.sun.com/mobility/midp/articles/fsm/
[10] D. G. A. Mobach, B. J. Overeinder, N. J. E. Wijngaards, and F. M. T. Brazier. Managing agent life cycles in open distributed systems. In Proceedings of the 2003 ACM symposium on Applied Computing, pages 61-65, 2003.
[11] M. B. Chhetri, I. Mueller, S. K. Goh, and R. Kowalczyk. ASAPM—An Agent-Based Framework for Adaptive Management of Composite Service Lifecycle. Web Intelligence and Intelligent Agent Technology, International Conference on, 0:444-448, 2007.
[12] R. Belter. Towards a Service Management System in Virtualized Infrastructures. Services Computing, IEEE International Conference on, 2:47-51, 2008.
[13] T. G. J. Schepers, M. E. Iacob, and P. A. T. V. Eck. A lifecycle approach to SOA governance. In SAC '08: Proceedings of the 2008 ACM symposium on Applied computing, pages 1055-1061, New York, N.Y., USA, 2008. ACM.

[14] F. Casati, S. Ceri, B. Pernici, and G. Pozzi. Workflow Evolution. In Data and Knowledge Engineering, pages 438-455. Springer Verlag, 1996.
[15] C. tsai Liu, S. kuo Chang, and P. K. Chrysanthis. Database schema evolution using EVER diagrams. In In Proceedings of the Workshop on Advanced Visual Interfaces, pages 123-132, 1994.
[16] B. Benatallah, F. Casati, F. Toumani, J. Ponge, and H. R. M. Nezhad. Service Mosaic: A Model-Driven Framework for Web Services Life-Cycle Management. IEEE Internet Computing, 10(4):55-63, 2006.
[17] Y.-H. Liu and J.-J. Jeng. Service Information Hub for Service Lifecycle Management: A Progress Report. E-Business Engineering, IEEE International Conference on, 0:453-459, 2007.
[18] OASIS. Web Services Business Process Execution Language Version 2.0, 2007. OASIS Standard.
[19] D. Cybok. A Grid Workflow Infrastructure. In Proc. of Workflow in Grid Systems Workshop in GGF10, 2004.
[20] J Boss Documentation. JBoss jBPM jPDL User Guide, 2008. [Online] http://docs.jboss.com/jbpm/v3.2/userguide/html.
[21] M. Dumas, A. H. M. T. Hofstede, N. Russell, H. M. W. Verbeek, and P. Wohed. Life After BPEL. In WS-FM 2005, volume 3670 of Lecture Notes in Computer Science, pages 35-50. Springer-Verlag, 2005.
[22] System and method for operating workflow. U.S. Pat. No. 6,931,404.
[23] L. W. F. Chaves, L. M. S. de Souza, J. Muller, and J. Anke. Service lifecycle management infrastructure for smart items. In MidSens '06: Proceedings of the international workshop on Middleware for sensor networks, pages 25-30, New York, N.Y., USA, 2006. ACM.
[24] W. M. P van der Aalst and S. Jablonski. Dealing with workflow change: identification of issues and solutions. International Journal of Computer Systems Science and Engineering, 15(5):267-276, September 2000.
[25] L. Capra. Addressing soundness and efficiency issues in dynamic processes: a reflective PN-based modeling approach. In SpringSim '08: Proceedings of the 2008 Spring simulation multiconference, pages 256-264, New York, N.Y., USA, 2008. ACM.
[27] L. Capra and W. Cazzola. A Petri-Net Based Reflective Framework for the Evolution of Dynamic Systems. Electr. Notes Theor. Comput. Sci., 159:41-59, 2006.
[27] E. Badouel and J. Oliver. Reconfigurable Nets, a Class of High Level Petri Nets Supporting Dynamic Changes. In INRIA Research Report, PI-1163, pages 129-145, 1998.
[28] L. Cabac, M. Duvigneau, D. Moldt, and H. Rölke. Modeling Dynamic Architectures Using Nets-Within-Nets. In ICATPN, pages 148-167, 2005.
[29] L. Ardissono, R. Furnari, A. Goy, G. Petrone, and M. Segnan. Fault TolerantWeb Service Orchestration by Means of Diagnosis. In Software Architecture, Third European Workshop, EWSA 2006, pages 2-16, 2006.
[30] A. Hicheur and K. Barkaoui. Modelling collaborative workflows using recursive ECATNets. In NOTERE '08: Proceedings of the 8th international conference on New technologies in distributed systems, pages 1-11, New York, N.Y., USA, 2008. ACM.
[31] M. Reichert and P. Dadam. ADEPTflex: Supporting Dynamic Changes of Workflow without Loosing Control. Journal of Intelligent Information Systems, 10:93-129, 1998.
[32] Workflow as data-transition driven, scriptable state machines. U.S. Pat. No. 7,607,130.
[33] Workflow Management Software Overview. EP1332418.
[34] System and method for operating workflow. U.S. Pat. No. 6,931,404.
[35] E. Keller and G. Kar. Dynamic Dependencies in Application Service Management. In Proc. of the Int'l Conf. on Parallel and Distributed Processing Techniques and Applications, Las Vegas, 2000.
[36] P. Dini and G. V. Bochmann. Specifying Lifecycles of Object Interactions within Distributed Systems. Systems Management Workshop, IEEE International, 0:82, 1996.
[37] F. Majer, P. Freudenstein, and M. Nussbaumer. Roadmap towards Lifecycle Support for Highly Distributed Web-Based Systems. Web Engineering, International Conference on, 0:340-343, 2008.
[38] W. Brauer, W. Reisig, and G. Rozenberg, editors. Proceedings of an Advanced Course on PetriNets: Central Models and Their Properties, Advances in Petri Nets 1986-Part 1, London, UK, 1987. Springer-Verlag.
[39] D. Karastoyanova, R. Buchmann, and T. U. Darmstadt. A.: Development life cycle of web service based business processes enabling dynamic invocation of web services at run time. In: ICSOC05: In Proc. of the 3rd International Conference on Service Oriented Computing, 2004.
[40] J. Yang, M. P. Papazoglou, B. Orrins, and W.-J. Van Heuvel. A Rule Based Approach to the Service Composition Life-Cycle. Web Information Systems Engineering, International Conference on, 0:295, 2003.
[41] H. Pfeffer, D. Linner, I. Radusch, and S. Steglich. The Bio-inspired Service Life-Cycle: An Overview. Autonomic and Autonomous Systems, International Conference on, 0:27, 2007.
[42] Apparatus-and-method-for-executing-workflow. US20100011256.
[43] Method for Fault Handling in a Co-operative Workflow Environment. U.S. Pat. No. 7,669,074.

1-16. (canceled)

17. A computer implemented method for service lifecycle management in networked environments, comprising monitoring incoming events by using rule-based adaptation mechanisms enabling the transformation of services to change in response to user predefined application information, delivering to said rule-based adaptation mechanism said user predefined application information and further using said rule-based adaptation mechanism to process and enforce at run time at least said user predefined application information, wherein a state diagram defining a workflow of a service lifecycle is used and a user predefined application information is mapped to a data model using software engines, to obtain a set of rules including the workflow tasks and/or new states and/or transitions of said workflow of said state diagram, wherein the method comprises using software engines performing following steps:
(a) checking said set of rules against a set of predefined adaptation policies selected among behavioural and non-behavioural policies that check business and performance criteria, avoiding going beyond a pre-defined budget, or maximize the cost to benefit ratio and comparing user predefined information with older information, analysing the differences found and enforcing required actions by deploying new software elements or virtual machines, depending on the results of said differences analysis;
(b) loading said set of rules into a rule controller, said predefined adaptation policies being implemented into said rule-based adaptation mechanism; and
(c) carrying out, in order to implement said enforcing at run time of said at least user predefined application information, a monitoring of incoming events that trigger state changes reflected in said stated diagram by enforcing the set of rules loaded in the rule controller.

18. A method as per claim 17, comprising analysing dependencies between services forming said application in order to generated said set of rules.

19. A method as per claim 18, comprising translating said user predefined application information before checking it against said set of predefined adaptation policies.

20. A method as per claim 17, comprising deploying and/or modifying the services forming the application before a stage of said monitoring incoming events is carried out.

21. A method as per claim 17, comprising storing said monitored incoming events in a database, analysing the stored events in order to find hidden information patterns and new usable rules to optimize the application lifecycle and loading said new usable rules into said rule controller.

22. A method as per claim 21, comprising checking said new usable rules against said set or another set of predefined adaptation policies that check business and performance criteria, before loading it into said rule controller.

23. A method as per claim 21, comprising conditioning at least the loading of said new usable rules into said rule controller to the decision of an operator.

24. A method as per claim 21, comprising carrying out said analysis of stored events by means of advanced data mining techniques.

25. A method as per claim 17, wherein said comparison of predefined and older information is carried out to check which components have been added, how the dependencies have changed and what is needed to reach the new run time state from the previously deployed architecture.

26. A method as per claim 17, wherein said deployed new software elements or virtual machines are further configured to interoperate with the rest of previously deployed elements comprising the whole application.

27. A method as per claim 17, comprising dynamically changing or putting on a hold state said rules loaded into said rule controller and said incoming events.

28. A method as per claim 27, wherein said hold state refers to an unobserved state.

29. A method as per claim 17, comprising observing said rules loaded into said rule controller as soon as they are loaded.

30. A method as per claim 17, wherein said set of rules include new states and transitions of said workflow.

31. A computer implemented system for service lifecycle management in networked environments, of the type comprising computing means implementing, by software and/or hardware elements, a method for service lifecycle management in networked environments comprising defining the workflow of a service lifecycle by means of a state diagram and following its monitoring and triggering using rule-based adaptation mechanisms enabling the transformation of services to change in response to user predefined application information, wherein said computing means comprise at least one input for receiving user predefined application information, which declaratively defines the architecture of an application formed by several services or said architecture plus the behaviour of the whole application under a series of variable circumstances, and in that the computing means are arranged and intended for processing and enforcing at run time, using said rule-based adaptation mechanism, at least said user predefined application information.

32. A system as per claim 31, comprising interrelated elements arranged and intended for carrying out the actions of the following method:
checking said set of rules against a set of predefined adaptation policies selected among behavioural and non-behavioural policies that check business and performance criteria, avoiding going beyond a pre-defined budget, or maximize the cost to benefit ratio and comparing user predefined information with older information, analysing the differences found and enforcing required actions by deploying new software elements or virtual machines, depending on the results of said differences analysis;
loading said set of rules into a rule controller, said predefined adaptation policies being implemented into said rule-based adaptation mechanism; and
carrying out, in order to implement said enforcing at run time of said at least user predefined application information, a monitoring of incoming events that trigger state changes reflected in said stated diagram by enforcing the set of rules loaded in the rule controller.
